(19) United States
(12) Patent Application Publication
(10) Pub. No.: US 2020/0215976 A1
(43) Pub. Date: Jul. 9, 2020

(54) METHOD AND APPARATUS FOR CONTROLLING OPERATION OF SIDE AND REAR MONITORING CAMERA SYSTEM

(71) Applicants: Hyundai Motor Company, Seoul (KR); Kia Motors Corporation, Seoul (KR); SL Corporation, Daegu (KR)

(72) Inventors: Hyun Sub Kim, Seoul (KR); Keun Sig Lim, Gyeonggi-do (KR); Chan Mook Choi, Incheon (KR); Chang Ju Kim, Daegu (KR); Dong Uk Kang, Seoul (KR); Seok Keon Kwon, Anyang-si (KR)

(21) Appl. No.: 16/823,194

(22) Filed: Mar. 18, 2020

Related U.S. Application Data
(63) Continuation-in-part of application No. 15/294,647, filed on Oct. 14, 2016.

(30) Foreign Application Priority Data
May 2, 2016 (KR) 10-2016-0053814

(51) Int. Cl. B60R 1/00; H04N 7/18; B60R 25/30

(52) U.S. Cl. CPC B60R 1/00; B60R 2300/105; B60R 25/305; H04N 7/181

(57) ABSTRACT

A method and an apparatus of controlling an operation of a side and rear watching camera monitor system of a vehicle are provided. The method and apparatus provide side and rear information based on a user's convenience and request by receiving a request signal for securing of side and rear visual fields of a user as well as vehicle driving and displaying side and rear visual fields on a display unit according to user's necessity. More particularly, the side and rear watching camera monitor system displays a side and a rear visual field image to a driver even when the driver unlocks a door using a smart key, exits the vehicle that is not turned on, and turns on the vehicle.

### CROSS-REFERENCE TO RELATED APPLICATION

This application is a Continuation-in-Part application of U.S. patent application Ser. No. 15/294,647 filed on Oct. 14, 2016 which claims under 35 U.S.C. § 119(a) the benefit of priority to Korean Patent Application No. 10-2016-0053814 filed on May 2, 2016, the entire contents of which are incorporated herein by reference.

### BACKGROUND

### (a) Technical Field

The present disclosure relates to a method and an apparatus of controlling an operation of a side and rear watching camera monitor system, and more particularly, to a method and apparatus of controlling an operation of a side and rear watching camera monitor system, by operating a controller of the side and rear watching camera monitor system to provide a side image and a rear image to a user via a smart key signal, a door open/close signal, an ignition signal, and a switch signal of the side and rear watching camera monitor system to perform an operation of a side and rear monitoring camera based on user convenience.

### (b) Background Art

Recently, along with the development of image capture and display technologies, a sight securing device replacing a conventional side mirror for detecting side and rear information of a vehicle, that is, a monitoring device for displaying a side image and a rear image information captured by an imaging device (e.g., a camera, video camera, or the like) through a display unit to allow a driver to view the information has been developed. A vehicle including such a vehicle side and rear watching camera monitor system includes a small side camera configured to capture an image around the vehicle at both right and left sides of the vehicle, etc. instead of a conventional side mirror. In addition, an image signal acquired by the side camera is processed and displayed on a side display unit inside the vehicle to allow a driver to detect the side and rear of the vehicle using image information displayed on the display.

A system of the related art provides a side and rear watching camera monitor system configured to display an image captured by a camera attached to an external surface of a vehicle on a display unit facing an inner part of the vehicle. FIG. 1 illustrates the configuration of a vehicle side and rear watching camera monitor system of the related art that is assembled as one integrated body 10. In addition, the body 10 includes an integrated component including a camera 14, a display unit 12, a controller, and so on, and a camera housing 13 and a monitor housing 11 are configured as one body 10.

As disclosed in the related art, a vehicle including a side and rear watching camera monitor system installed therein displays a vehicle side image and a vehicle rear image on the display unit 12 to provide driving convenience. However, when there is a request for an exiting condition and riding condition of a driver or for securing of side and rear visual fields of the driver in a non-driving state, the vehicle is not capable of displaying a vehicle side image and a vehicle rear image. In other words, when a request signal for securing of side and rear visual fields of a user is received in various situations as well as while the vehicle is being driven, a control method of displaying a side and a rear environment of the vehicle is not provided.

### SUMMARY

The present invention provides a method and apparatus of controlling an operation of a side and rear watching camera monitor system of a vehicle, by receiving a request signal for securing of side and rear visual fields of a user as well as vehicle driving and displaying side and rear visual fields on a display to provide side and rear information according to user convenience and a user request. The present invention also provides a method of controlling an operation of a side and rear watching camera monitor system of a vehicle to provide an image based on a driver's sight request by determining a user request according to various signal, that is, by sequentially determining a plurality of signals received by a side and rear watching camera monitor system.

It is to be understood that both the foregoing general description and the following detailed description of the present invention are exemplary and explanatory and are intended to provide further explanation of the invention as claimed. The aforementioned method of controlling an operation of a side and rear watching camera monitor system may have the following configuration.

In one aspect, the present invention provides an apparatus for controlling an operation of a side and rear watching camera monitor system that may include an imaging device (e.g., a single camera, video camera, or the like) configured to capture or obtain a side image and a rear image of a vehicle, a display unit configured to display the captured image, and a controller configured to determine an initial condition of an operation of the camera monitor system and display the captured image on the display unit based on a user request. Additionally, the controller is configured to determine the user request signal for a side image and a rear image and supply power to the controller to display the side image and the rear image on the display unit for preset time when the initial condition of the vehicle is satisfied.

In an exemplary embodiment, the initial condition of an operation of the camera monitor system may satisfy all of an ignition (IGN) on state of the vehicle, a door closed state, and an off state of a switch of the side and rear watching camera monitor system. In addition, the user request signal for a side image and a rear image may include a case in which the switch of the side and rear watching camera monitor system is changed to an off state from an on state, a case in which a door of the vehicle is changed to a close state from an open state, and a case in which an IGN on state of the vehicle is changed to an off state.

The controller may be configured to display the side image and the rear image on the display unit for preset time and re-determine whether the initial condition is satisfied. In addition, the controller may be configured to re-determine the initial condition and the user request signal for a side image and a rear image when the user request signal for a side image and a rear image is not present.

In one aspect, the present invention provides a method of controlling an operation of a side and rear watching camera monitor system that may include determining whether a controller of the side and rear watching camera monitor system is in an initial condition of the side and rear watching camera monitor system, supplying power to the controller and determining whether the controller is in the initial condition when the controller does not satisfy the initial condition of the side and rear watching camera monitor system, and determining a smart key signal when the side and rear watching camera monitor system satisfies the initial condition, supplying power to the controller to display a side image and a rear image on a display unit for preset time and determining whether the controller is in the initial condition when the smart key signal is a door unlock signal, terminating the side and rear watching camera monitor system when the smart key is a door lock signal, and determining the user request signal for a side image and a rear image when the smart key signal is not present, and displaying the side and rear images on the display unit for preset time and determining whether the controller is in the initial condition when the user request signal for a side image and a rear image is received and determining of whether the controller is in the initial condition when the user request signal for a side image and a rear image is not received.

The initial condition of an operation of the camera monitor system may satisfy all of an IGN on state of the vehicle, a door closed state, and an off state of a switch of the side and rear watching camera monitor system. In addition, the user request signal for a side image and a rear image in the displaying of the side and rear images may further include determining whether the switch of the side and rear watching camera monitor system is changed to an off state from an on state prior to determination of the initial condition, supplying power to the controller to display the side and rear images on the display unit for preset time and returning to the determining of whether the controller is in the initial condition when the switch of the side and rear watching camera monitor system is changed to an off state from an on state, and determining whether the door is changed to a closed state from an open state prior to the determination of the initial condition when the side and rear watching camera monitor system is not changed to an off state from an on state, and supplying power to the controller to display the side and rear images on the display unit for preset time and returning to the determining of whether the controller is in the initial condition when the door is changed to a closed state from an open state prior to determination of the initial condition and determining whether the IGN on state of the vehicle is changed to an off state prior to the determination of the initial condition when the door is not changed to a closed state from an open state.

The method may further include supplying power to the controller to display the side and rear images on a display unit for preset time and returning to the determining of whether the controller is in the initial condition when an IGN on state of the vehicle is changed to an off state from an on state, and returning to the determining of whether the controller is in the initial condition when the IGN on state of the vehicle is not changed to an off state.

The returning to the determining of whether the controller is in the initial condition may include subtracting a preset count value, determining whether the subtracted count value is 0, and additionally subtracting the subtracted count value, supplying power to the controller, and returning to the determining of whether the controller is in the initial condition when the subtracted count value is not 0, and powering off the controller and terminating the side and rear watching camera monitor system when the count value is 0. In addition, the method may include performing an operation of a regulator of the side and rear watching camera monitor system in the displaying of the side and rear images on the display unit, and supplying power to the side and rear watching camera monitor system through the regulator and processing an image signal.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 illustrates a side and rear watching camera monitor system attached to an external surface of a vehicle according to the related art;

FIG. 2 is a block diagram illustrating a configuration with regard to a method of controlling an operation of a side and rear watching camera monitor system according to an exemplary embodiment of the present invention;

FIG. 3 is a block diagram illustrating a configuration of a controller in a method of controlling an operation of a side and rear watching camera monitor system according to an exemplary embodiment of the present invention;

FIG. 4 is a flowchart illustrating a method of controlling an operation of a side and rear watching camera monitor system according to an exemplary embodiment of the present invention;

FIG. 5 is a flowchart for determination of a user visual field request signal of a method of controlling an operation of a side and rear watching camera monitor system according to an exemplary embodiment of the present invention; and

FIG. 6 is a flowchart showing defect inspection of a method of controlling an operation of a side and rear watching camera monitor system.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will now be described more fully with reference to the accompanying drawings, in which exemplary embodiments of the invention are shown. The invention may, however, be embodied in many different forms and should not be construed as being limited to the embodiments set forth herein; rather, these exemplary embodiments are provided so that this disclosure will be thorough and complete, and will fully convey the concept of the invention to those skilled in the art. Also, the terms, such as ‘unit’ or ‘module’, etc., should be understood as a unit that processes at least one function or operation and that may be embodied in a hardware manner, a software manner, or a combination of the hardware manner and the software manner.

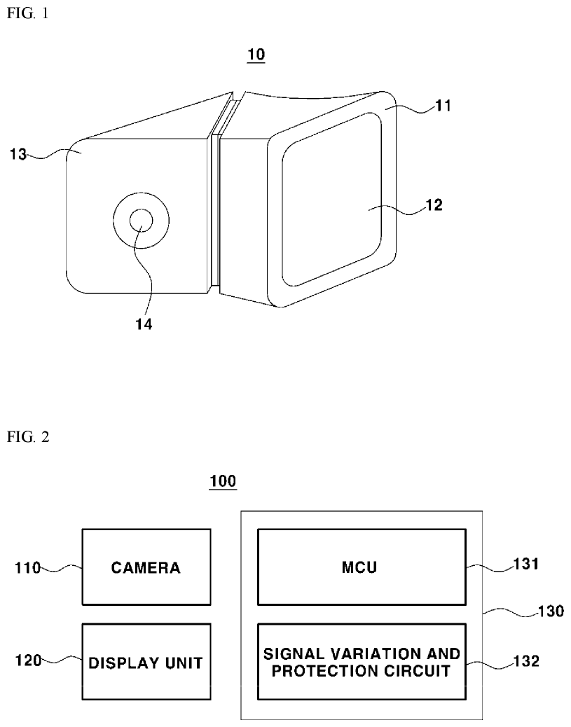

FIG. 2 is a block diagram illustrating a side and rear watching camera monitor system 100 according to an exemplary embodiment of the present invention. The side and rear watching camera monitor system 100 may include a camera 110 (e.g., a single imaging device so as to include a video camera, a camera, or the like), a display unit 120, and a controller 130. The imaging device 110 according to the present invention may include a moveable lens (not shown) configured to move in upward, downward, right, and left directions with respect to a center of the imaging device 110. The moveable lens may be adjusted through a direction adjustment button installed within a vehicle (not shown).

A case of the imaging device 110 may include a linear or round type extension portion that has an upper end portion that extends frontward of the vehicle (e.g., rearward of the vehicle). Accordingly, the extension portion functions as a hat or an umbrella for protection of a lens unit of the imaging device 110 to provide a clear view despite rain, snow, etc. during vehicle driving. In addition, a side image and a rear image both captured by the single imaging device 110 may be provided to the driver through the display unit 120 positioned within the vehicle. The display unit 120 according to the present invention may be positioned within the vehicle and, thus, may be positioned inside an A-pillar or window of the vehicle.

In particular, the display unit 120 may include a liquid crystal display (LCD), a light emitting diode (LED), an organic light emitting diode (OLED), or the like. In addition, the display unit 120 according to the present invention may be configured with an OLED inserted into an A-pillar. The controller 130 according to the present invention may be configured to display a side image and a rear image received from imaging device 110 on the display unit 120 and set an image display angle or an image display height or area based on a user request. The controller 130 may also be configured to perform a fail-safe function in the case of failure, error, or malfunction of the imaging device 110 of the vehicle or connection components connected to the imaging device 110.

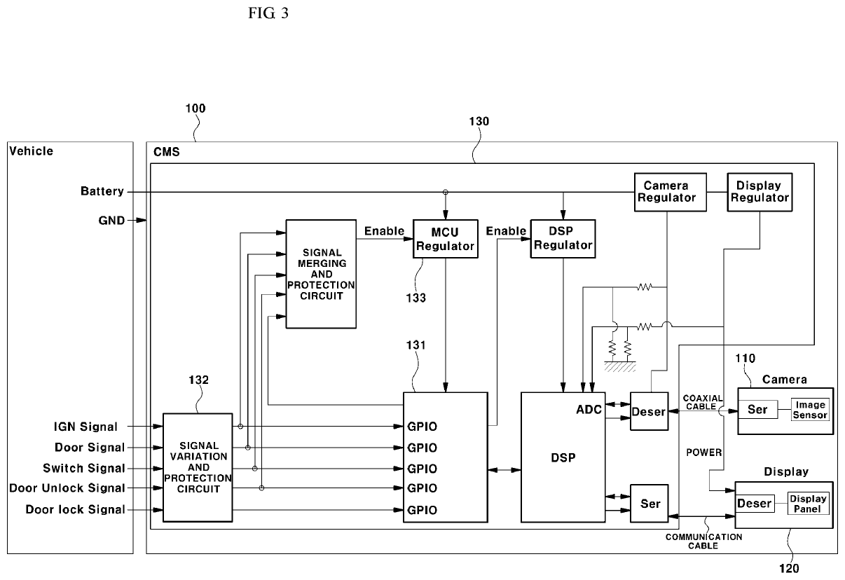

In a control method of operating the side and rear watching camera monitor system 100 according to the present invention, the controller 130 may be configured to receive power supplied from a battery integrated into the vehicle and attached to the system and receive power for driving the system via a plurality of relays connected to the battery and corresponding to respective components of the controller 130. FIG. 3 is a block diagram illustrating a configuration of the controller 130 of the side and rear watching camera monitor system 100 according to the present invention.

According to an exemplary embodiment of the present invention, a side and rear watching camera monitor system (e.g., a camera monitoring system (CMS)) may include the controller 130 which includes a micro control unit (MCU) 131, a signal variation and protection circuit 132, and so on. The signal variation and protection circuit 132 according to the present invention may be configured to receive a plurality of signals generated from a vehicle and, in detail, receive an IGN signal, a vehicle door signal, a switch signal of the side and rear watching camera monitor system, a vehicle door open/close signal, and so on. Each of the received signals may be transmitted to the MCU 131 through the signal variation and protection circuit 132.

According to the signal transmitted to the MCU 131, the MCU 131 may be configured to execute a regulator of a digital signal processor (DSP) and operate a digital signal processor (DSP). As described above, when a side image and a rear image is displayed on a display unit, the regulator of the side and rear watching camera monitor system may be operated, and the side and rear watching camera monitor system may receive power through the regulator to process an image signal and to display a side image and a rear image on the display unit 120 based on a user request.

The controller 130 may be configured to decompose and measure a voltage applied to the controller 130 from a battery (not shown) positioned in a vehicle and determine whether the measured voltage falls within a normal range (e.g., about 4.5V to 13V and preferably about 6.5V). In particular, the controller 130 may be configured to decompose a supply voltage supplied from the battery, to convert the voltage through an AD converter of the MCU 131, and measure the converted voltage.

When the voltage supplied to the controller 130 is beyond or outside of the normal range, there is a malfunction possibility of the camera monitor system 100 increases, and thus, at least one device of a power supply of the camera 110, a power supply of the display unit 120, or an IC for performing control, included in the camera monitor system 100, may be turned off.

In addition, the controller 130 may be configured to transmit a malfunction signal to the vehicle and enable the user to indicate trouble with the voltage supplied to the camera monitor system 100 from the vehicle. When the voltage supplied to the controller 130 falls within the normal range, the controller 130 may be configured to perform defect inspection of the camera 110 and defect inspection of the display unit 120. When the voltage supplied from the vehicle falls within the normal range, the controller 130 may be configured to perform defect inspection of the camera 110.

While performing defection inspection of the camera 110, the controller 130 may be configured to determine whether the voltage applied to the camera 110 from the AD converter falls within the normal range using the MCU 131 or a digital signal processing device. The controller 130 may be configured to perform communication inspection between the camera 110 and the controller 130, and thus, may be configured to determine whether communication between a deserialize circuit unit and a serialize circuit unit is performed normally.

In particular, the controller 130 may be configured to use an I2C communication method between the camera 110 and the controller 130 and determine whether the digital signal processing device is connected to a deserializer as a deserialize circuit. When the digital signal processing device is communication-connected to the deserialize circuit, the controller 130 may be configured to check and determine whether the digital signal processing device is connected to a serializer as a serialize circuit using an I2C communication method.

The serializer that receives a plurality of pieces of information from an image sensor included in the camera 110 may be configured as the serialize circuit, and the deserializer configured to transmit information received from the serializer in parallel may be connected to the deserialize circuit. Accordingly, the controller 130 may be configured to perform communication inspection as well as power inspection while performing defect inspection of the camera 110, and thus, may be configured to determine whether the digital signal processing device sequentially or simultaneously communicates with the deserialize circuit and the serialize circuit in the communication inspection.

Further, the controller 130 may be configured to perform image data inspection in defect inspection of the camera 110, and thus, a sync signal indicating whether image data of the camera 110 is input to an image input port of the digital signal processing device may be examined and data integrity indicating whether the received image data is normal may be checked by the controller 130. The controller 130 may be configured to perform at least one response of an operation of powering off the camera 110 or an operation of indicating malfunction information to a user when defect of the camera 110 is measured in each of the above operations while performing the defect inspection of the camera 110.

The controller 130 may be configured to perform power inspection and communication inspection of the camera 110 and the controller 130 that are connected through one coaxial cable by connecting the controller 130 and the camera 110 via a power over coaxial (PoC) or power over Ethernet (PoE) coaxial cable while performing the defect inspection of the camera 110. In particular, in the defect inspection of the camera 110, the controller 130 may be configured to convert the camera 110 into an off-state when a voltage does not fall within (e.g., is beyond) a normal range and may be configured to indicate malfunction information when determining communication abnormality in communication defect inspection.

The controller 130 may be configured to perform defect inspection of the display unit 120 after defect inspection of the camera 110 is performed, when defect of the camera 110 is not determined, or simultaneously with defect inspection of the camera 110. In defect inspection of the display unit 120, the controller 130 may be configured to sequentially or simultaneously perform power inspection and communication inspection. In the case of power inspection, the controller 130 may be configured to determine whether a voltage applied to the display unit 120 from the AD converter falls within a normal range using the MCU 131 or the digital signal processing device.

Inspection of power supplied to the display unit 120 from the controller 130 may be configured to measure and determine a voltage applied to the display unit 120 through a display regulator. In defect inspection of the display unit 120, when a voltage applied to the display unit 120 is determined to fall within a normal range, whether communication connection between the controller 130 and a panel of the display unit 120 is normal may be determined through communication inspection.

In particular, communication inspection of the display unit 120 may be performed using an I2C communication method, and thus, defect inspection may be performed using the same method as communication inspection of the camera 110. In other words, the controller 130 may be configured to perform communication inspection between the display unit 120 and the controller 130, and thus, may be configured to determine whether communication between the deserialize circuit unit and the serialize circuit unit is performed normally (e.g., without error). The controller 130 may be configured to use an I2C communication method between the display unit 120 and the controller 130, and thus, may be configured determine whether communication connection between the serializer as the serialize circuit of the controller 130 and the deserializer as the deserialize circuit positioned in the display unit 120 is normal (e.g., without malfunction or error).

The deserializer may be communication-connected to a display panel of the display unit 120 to transmit and receive information, the serializer positioned in the controller 130 may be configured to communicate with the deserializer positioned in the display unit 120 through a communication coaxial cable (single coaxial cable: COAX), and thus, the controller 130 may be configured to examine defect of a communication relationship of the controller 130 with the display unit 120 and components of the display unit 120.

When the digital signal processing device is communication-connected to the deserialize circuit, whether the digital signal processing device is connected to the serializer as the serialize circuit through I2C communication. Accordingly, the controller 130 may be configured to perform communication inspection as well as power inspection while performing defect inspection of the display unit 120, and thus, may be configured to determine whether the digital signal processing device sequentially or simultaneously communicates with the deserialize circuit and the serialize circuit in the communication inspection.

When power supplied to the display unit 120 is in an abnormal state or communication abnormality between the display unit 120 and the controller 130 occurs during defect inspection of the display unit 120, the controller 130 may be configured to maintain an off-state of the display unit 120 to prevent transmission of an output image to a panel of the display unit 120. In addition, when defect of the display unit 120 is discovered, the display unit 120 may be maintained in an off-state and alarm indication may be provided to a cluster for guiding a user about information on the defect.

In particular, in the case of defect inspection of the display unit 120, when a voltage is beyond a normal range, the display unit 120 may be converted into an off-state, and in the case of communication defect inspection, when communication abnormality is determined, an alarm indication may be output to provide malfunction information. As described above, the controller 130 may be configured to perform communication inspection of the camera 110 and communication inspection of the display unit 120, and may be configured to determine whether communication abnormality of the digital signal processing device with the deserialize circuit and serialize circuit is present using an I2C communication method.

As a result, the controller 130 may be configured to perform power inspection of determining whether a voltage applied to the camera monitor system 100 from a vehicle falls within a normal range and may also be configured to examine whether power supplied to the camera 110 and power supplied to the display unit 120 fall within a normal range, and thus, may be configured to determine the stability of the voltage applied to the controller 130 and the voltage applied from the controller 130.

In addition, the controller 130 may be configured to examine a communication state of the controller 130 with the camera 110 and the display unit 120, and thus, may be configured to detect whether a communication state of the deserialize circuit and the serialize circuit connected to the camera 110 and the display unit 120 is normal. Accordingly, the controller 130 may be configured to determine whether power of a vehicle and power supplied to the controller 130, the camera 110, and the display are in a normal state, may be configured to initialize the controller 130, the camera 110, and the display unit 120 in the case of the normal state, and may be configured to shut off power or to provide an alarm to a user when the power is not in the normal state.

In addition, the received signals may be transmitted to an MCU regulator 133. In particular, when conditions such as a smart key, an IGN signal, a door open/close signal, and a switch signal of the side and rear watching camera monitor system are satisfied, power may be supplied to the MCU 131 to operate the side and rear watching camera monitor system 100.

Additionally, according to an exemplary embodiment of the present invention, a switch of the side and rear watching camera monitor system 100 may be positioned in the vehicle and, thus, the side and rear watching camera monitor system 100 may include a component for connecting a user request for side and rear visual fields directly to the side and rear watching camera monitor system 100. In particular, a switch connected to the side and rear watching camera monitor system 100 may maintain an off state as a default value and, thus, may maintain an off state except when the switch is maintained in an on state for a user manipulation of the side and rear watching camera monitor system 100.

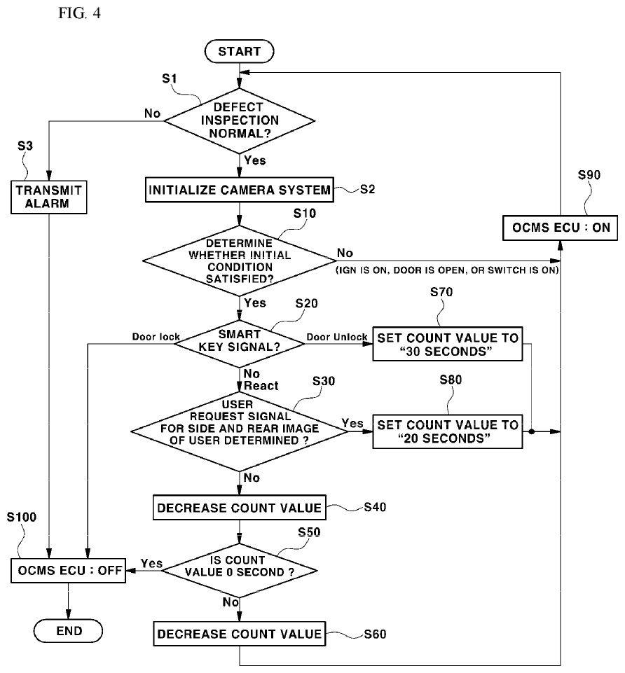

FIG. 4 is a flowchart of a method of controlling an operation of the side and rear watching camera monitor system 100 according to an exemplary embodiment of the present invention.

The controller 130 may be configured to perform defect inspection of original power supplied from a vehicle and a camera and a display unit of the camera monitor system. While performing the defect inspection, the controller 130 may be configured to determine whether power supplied from the vehicle falls within a normal range and determine whether a voltage applied to the camera and the display unit from the controller 130 falls within a normal range.

The controller 130 may be configured to perform defect inspection of a communication environment between the controller 130, and the camera and display unit. Particularly, while performing communication defect inspection of the camera and the display unit, the controller 130 may be configured to whether the digital signal processing device is in a normal communication state with a deserializer as a deserialize circuit and whether the digital signal processing device is communication-connected with a serializer as a serialize circuit through I2C communication.

As described above, the controller 130 may be configured to perform power defect inspection and communication defect inspection as defect inspection of the camera monitor system 100 and may be configured to initialize the controller 130, the camera, and the display unit when a result of the defect inspection does not fall within a normal range.

The controller 130 may be configured to maintain an off-state with respect to a configuration in which a voltage does not fall within the normal range and may be configured to provide an alarm to a user with respect to a configuration in which communication defect is determined. When the camera monitor system 100 is determined to be normal in defect inspection of the controller 130, whether an initial condition of the vehicle is satisfied may be determined (S10).

In the method of controlling an operation of the side and rear watching camera monitor system 100 according to the present invention, whether an initial condition of a vehicle, that is, an initial condition of a vehicle including the side and rear watching camera monitor system 100 is satisfied may be determined (S10). The method may be executed by a processor of the vehicle which communicates with the controller and receives the various signals.

Particularly, for the initial condition according to the present invention, whether an IGN state is an off state, whether a door is closed, and whether a side and rear watching camera monitor system switch state is an off state may be determined simultaneously. Accordingly, when all of the above conditions are satisfied, a smart key signal may be determined (S20). When at least one of a state in which an IGN state is an on state, a state in which a door is open, and a state in which a switch of a side and rear watching camera monitor system is turned on is detected, power may be supplied to the controller 130 of the side and rear watching camera monitor system 100 (S90) and then the method may return to an initial operation.

When an initial condition of a vehicle is satisfied, a smart key signal may be determined (S20), and when the smart key signal is a door lock signal, power to the controller 130 of the side and rear watching camera monitor system 100 may be shut off, and then a logic program may be terminated (S100), and when a door unlock (unlock release) signal is detected as the smart key signal, the controller 130 may be configured to display an image captured by the imaging device 110 on the display unit 120 for a preset time (S70), power may be supplied to the controller 130 of the side and rear watching camera monitor system 100 (S90), and the method may return to the initial operation.

However, in the determination of the smart key signal, when the smart key signal is not received for a preset time, a user request signal for a side image and a rear image may be detected (S30). When the user request signal for a side image and a rear image is present before the initial condition is determined, the controller 130 may be configured to display an image captured by the imaging device 110 on the display unit 120 for a time period set based on a user request (S80), power may be supplied to the controller 130 of the side and rear watching camera monitor system 100 (S90), and the method may return to the initial operation.

When the user request signal for a side image and a rear image is not present, power may be supplied to the controller 130 of the side and rear watching camera monitor system 100 (S90), and the method may return to the initial operation. Accordingly, when the user request signal for a side image and a rear image is not present, when power is supplied to the controller 130 of the side and rear watching camera monitor system 100 and the method returns to the initial operation, a number of times that the method returns to the initial operation may be set, and in this regard, the above set count value may be subtracted from a count value that is initially set in the controller 130 as a logic program circulates (S40) and whether the count value is 0 may be determined (S50). When the count value is 0, power may be shut off to the controller 130 to terminate the logic program (S100). When the count value is not 0 (e.g., greater than 0) in the determination of whether the count value is 0 (S50), the count value may be additionally rescued (S60), power may be supplied to the controller 130 o and the determination of whether the initial condition is satisfied (S10) may be re-performed.

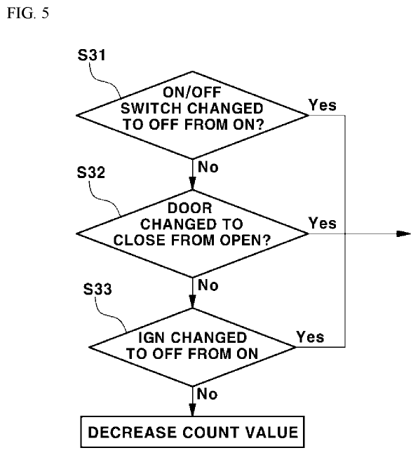

FIG. 5 is a flowchart illustrating sequential operations of determining the user request signal for a side image and a rear image according to an embodiment of the present invention. As illustrated in FIG. 5, the user request signal for a side image and a rear image may be determined by sequentially determining three signals. Whether a switch of the side and rear watching camera monitor system is changed to an off state from an on state prior to determination of the initial condition may be determined (S31). When the switch is changed to an off state from an on state prior to the determination of the initial condition, the controller 130 may be configured to display an image captured by the imaging device 110 on the display unit 120 for preset time (S80), power may be supplied to the controller 130 (S90), and the method may return to the initial operation. In particular, when the switch is changed to an off state from an on state, the controller 130 may be configured to display a side image and a rear image for about 30 seconds.

When the switch is not changed to an off state from an on state prior to the determination of the initial condition (S31), whether a door is changed to a closed state from an open state may be determined (S32). When the door is detected to be changed to a closed state from an open state prior to the determination of the initial condition, the controller 130 may be configured to display the image of the imaging device 110 on the display unit 120 for preset time (S80), power may be supplied to the controller 130 of the side and rear watching camera monitor system 100 (S90), and the method may return to the initial operation. As a method of setting an image of the imaging device 110 to be displayed on the display unit 120 for preset time, time for displaying an image may be initially set by a user, and when an image is displayed based on each operation, images may be separately set by the user.

In addition, as request signals for a side image and a rear image of the user are determined, the image display time may be set differently. Particularly, the controller 130 may be configured to display a side image and a rear image for about 20 seconds when the door is changed to a closed state from an open state. When the door is not changed to a closed state from an open state, whether IGN is changed to an off state from an on state prior to the determination of the initial condition is determined (S33), when the IGN is changed to an off state from an on state prior to the determination of the initial condition, the controller 130 may be configured to display an image of the imaging device 110 on the display unit 120 for preset time (S80), power may be supplied to the controller 130 of the side and rear watching camera monitor system 100 (S90), and then, the method may return to the initial operation. When the IGN is not changed to an off state from an on state (S33), power may be supplied to the controller 130 and the method may return to the initial operation a preset number of times.

As described above, in the determination of the user request signal for a side image and a rear image (S30), when the IGN is changed to an off state from an on state, exiting the vehicle may be anticipated (e.g., driver exit of the vehicle may be predicted) and power may be supplied to the rear monitoring camera monitor system 100 and the method may return to the initial operation as a method of securing side and rear visual fields when exiting the vehicle.

In other words, the controller 130 of the side and rear watching camera monitor system 100 that satisfies the initial condition may be configured to detect the user request signal for a side image and a rear image prior to the determination of the initial condition and, thus may be configured to display a side image and a rear image on the display unit 120 based on a user request. Accordingly, the user request signal for a side image and a rear image may be determined by a plurality of operations and, thus, whether the switch of the side and rear watching camera monitor system is changed to an off state from an on state, whether the door is changed to a closed state from an open-state, and whether IGN is changed to an off state from an on state may be determined sequentially.

As described above, when the user request signal for a side image and a rear image is detected or received by the processor, whether the switch of the side and rear watching camera monitor system is maintained in an on state, whether a vehicle door is open, and whether the IGN is maintained in an on state may be determined for user convenience. Accordingly, when at least one of the user side image and rear image request signal conditions is satisfied, power may be supplied to the controller 130 to display an image of the imaging device 110 on the display unit 120 for a preset time. Thus, a more complex visual field securing request signal of a user may be received and a side image and a rear image of a vehicle may be provided based on the request signal.

According to another exemplary embodiment of the present invention, a control logic of the side and rear watching camera monitor system 100 when a driver exits the vehicle will be described below. The controller 130 of the side and rear watching camera monitor system 100 according to the present invention may be configured to determine the initial condition of the system (S10). In particular, when the driver maintains IGN on state of the vehicle, the initial condition is not satisfied (S10) and, thus, power may be supplied to the side and rear watching camera monitor system 100 (S90) and the method may return to the initial operation. Then, the side and rear watching camera monitor system 100 may be configured to re-determine an initial condition of the vehicle (S10) and, thus, a state in which conversion into an IGN off state from an IGN on state is completed for exiting the vehicle may be satisfied.

Accordingly, when a separate switch signal of the side and rear watching camera monitor system 100 is not applied as a state in which the vehicle is maintained in an IGN off state and before a vehicle door is open, the initial condition of the camera monitor system may be satisfied. As described above, when the initial conditions are all satisfied and when there is no separate smart key signal, a user request signal for side and rear images may be determined. In particular, according to another exemplary embodiment of the present invention, an IGN on state may be converted into an off state prior to the determination of the initial condition to detect the user request signal for a side image and a rear image.

As described above, according to the user request signal for a side image and a rear image, a side image and a rear image may be output on the display unit 120 for preset period of time, for example, about 20 seconds (S80), power may be supplied to the controller 130 of the camera monitor system (S90), and the method may return to an initial operation. Further, control logic may be repeated until a count value is 0 (S50). When there is no separate a side image and a rear image request signal of a user, power of the controller 130 of the camera monitor system may be shut off (S100) to terminate a logic program or a smart key lock signal of the user may be received and the side and rear watching camera monitor system may be powered off to terminate the logic program.

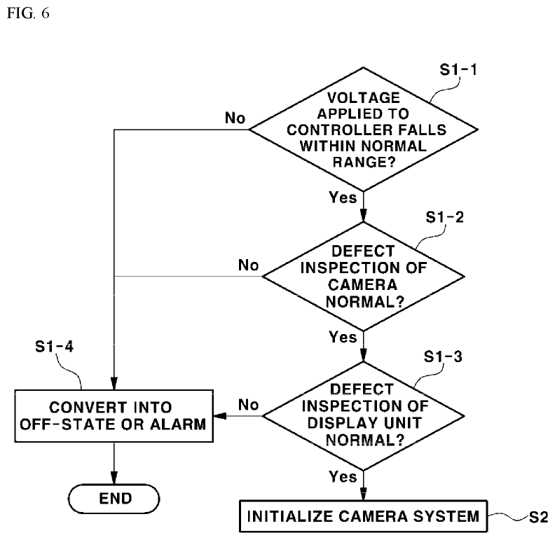

FIG. 6 is a flowchart showing a procedure in which a side and rear watching camera monitor system performs defect inspection and is initialized before an initial condition is determined.

As shown in the drawing, determining defect of the camera monitor system may include determining whether an original voltage applied to a controller from a vehicle falls within a normal range (S1-1). When the voltage applied to the controller from a battery of the vehicle is instable, a camera mirror system may be converted into an off-state and a user may be notified about information regarding the instable voltage state (S1-4).

When the voltage applied to the controller falls within a normal range, defect inspection of the camera may be performed (S1-2), and thus, the defect inspection of the camera may be performed by decomposing the voltage applied to the camera from the controller to determine whether the voltage falls within a normal range and by determining whether communication defect between the controller and the camera is present. In the defect inspection of the camera, voltage defect inspection and communication defect inspection may be simultaneously or sequentially performed.

When the defect inspection of the camera is performed, if power supplied to the camera is beyond a normal range or communication defect is detected as the defect of the camera, the controller may be operated to convert the camera into an off-state or to transmit an alarm to indicate the defect of the camera to the user (S1-4). When the camera is in a normal state as a result of the defect inspection of the camera, defect inspection of the display unit may be performed.

The defect inspection of the display unit may be performed by determining whether a voltage applied to the display unit from the controller falls within a normal range, and an operation of examining a communication state between the controller and the display unit may be performed sequentially or simultaneously (S1-3). When the defect inspection of the display unit is performed, if power supplied to the camera does not fall within (e.g., is beyond) a normal range or communication defect is discovered as the defect of the display unit, the controller may be operated to convert the display unit into an off-state or to transmit an alarm to indicate the defect of the display unit to the user (S1-4). When the voltage applied to the controller falls within a normal range, if the camera and the display unit are operated in a normal state, the camera monitor system may be initialized and then whether an initial condition is satisfied may be determined.

According to another exemplary embodiment of the present invention, when the voltage applied to the controller from the vehicle falls within a normal range, the defect inspection of the camera and the defect inspection of the display unit may be performed simultaneously.

The present invention may have the following effects according to combinations and use relationship of the aforementioned embodiments and the following configurations.

First, a side visual field image and a rear visual field image of a vehicle may be displayed based on a side and a rear visual field securing request signal of a vehicle user and, thus, side and rear visual fields of the vehicle may be provided according to user's necessity.

Second, a plurality of user side and rear visual field securing request signals may be provided and, thus, a user request may be more accurately determined to provide side and rear visual fields.

Third, the vehicle functional safety international standard (IOS26262) and related regulations may be satisfied.

Lastly, according to the present invention, the user may automatically terminate a side and rear watching camera monitor system at desired time, to prevent a vehicle battery provided as power from being discharged.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. An apparatus for controlling an operation of a side and rear watching camera monitor system, comprising:
an imaging device configured to capture a side image and a rear side image of a vehicle;
a display unit configured to display the image captured by the imaging device; and
a controller configured to determine an initial condition of an operation of the side and rear watching camera monitor system and display the image on the display unit based on a user request,
wherein the controller is configured to perform defect inspection of the camera monitor system and to detect a user request signal for a side image and a rear image and receive power to display the side and rear images for preset period of time when the initial condition of the vehicle is satisfied.

2. The apparatus of claim 1, wherein the initial condition of an operation of the side and rear watching camera monitor system satisfies all of an ignition (IGN) off state of the vehicle, a door closed state, and an off state of a switch of the rear side monitoring camera monitor system.

3. The apparatus of claim 1, wherein the user request signal for a side image and a rear image includes when the switch of the side and rear watching camera monitor system is changed to an off state from an on state when a door of the vehicle is changed to a closed state from an open state, and when an ignition (IGN) on state of the vehicle is changed to an off state.

4. The apparatus of claim 3, wherein the controller is configured to display the side and rear images for the preset period of time and re-determine whether the initial condition is satisfied.

5. The apparatus of claim 1, wherein the controller is configured to re-determine the initial condition and the user request signal for a side image and a rear image a preset number of times when the user request signal for a side image and a rear image is not present.

6. The apparatus of claim 1, wherein, while performing the defect inspection, the controller is configured to determine whether a voltage applied to the controller from the vehicle falls within a normal range and to perform defect inspection of the camera and defect inspection of the display unit.

7. The apparatus of claim 6, wherein, while performing the defect inspection of the camera, the controller is configured to determine whether the voltage applied to the camera from the controller falls within the normal range and to perform communication defect inspection between the controller and the camera.

8. The apparatus of claim 6, wherein, while performing the defect inspection of the display unit, the controller is configured to determine whether a voltage applied to the display unit form the controller falls within a normal range and to perform communication defect inspection between the controller and the display unit.

9. The apparatus of claim 6, wherein, when determining that defect of the camera monitor system is present according to the defect inspection, the controller is configured to convert the camera monitor system into an off-state or to indicate an alarm.

10. A method of controlling an operation of a side and rear watching camera monitor system, comprising:
performing defect inspection;
when defect of the camera monitor system is not determined in the performing the defect inspection, determining, by a controller, whether the side and rear watching camera monitor system is in an initial condition;
receiving, by the controller, power and performing defect inspection again when the initial condition of the side and rear watching camera monitor system is not satisfied, and determining a smart key signal when the side and rear watching camera monitor system satisfies the initial condition;
displaying, by the controller, a side image and a rear image on a display unit for preset period of time and performing defect inspection when the smart key signal is a door unlock signal, terminating the side and rear watching camera monitor system when the smart key signal is a door lock signal, and determining a user request signal for a side image and a rear image when the smart key signal is not present; and
displaying the side and rear images on the display unit for the preset period of time and performing defect inspection again when the user request signal for a side image and a rear image is received and performing defect inspection when the user request signal for a side image and a rear image is not received.

11. The method of claim 10, wherein the initial condition of an operation of the side and rear watching camera monitor system satisfies all of an ignition (IGN) off state of the vehicle, a door closed state, and an off state of a switch of the side and rear watching camera monitor system.

12. The method of claim 10, wherein the user request signal for a side image and a rear image in the displaying of the side and rear images includes:
determining, by the controller, whether the switch of the side and rear watching camera monitor system is changed to an off state from an on state prior to the determination of the initial condition;
displaying, by the controller, the side and rear images on the display unit for the preset period of time and performing defect inspection again when the switch of the side and rear watching camera monitor system is changed to an off state from an on state, and determining whether the door is changed to a close state from an open state prior to the determination of the initial condition when the side and rear watching camera monitor system is not changed to an off state from an on state; and
displaying, by the controller, the side and rear images on the display unit for preset time and returning to performing defect inspection when the door is changed to a closed state from an open state prior to the determination of the initial condition and determining whether an ignition (IGN) on state of the vehicle is changed to an off state prior to the determination of the initial condition when the door is not changed to a closed state from an open state.

13. The method of claim 12, further comprising:
displaying, by the controller, the side and rear images on the display unit for the preset period of time and performing defect inspection again when an IGN on state of the vehicle is changed to an off state; and
determining, by the controller, again performing defect inspection when the IGN on state of the vehicle is not changed to an off state,
wherein the determining again of whether performing defect inspection includes:
subtracting a preset count value;
determining whether the subtracted count value is 0; and
additionally subtracting the subtracted count value, determining again performing defect inspection when the subtracted count value is not 0, and powering off and terminating the side and rear watching camera monitor system when the count value is 0.

14. The method of claim 10, further comprising:
performing, by the controller, an operation of a regulator of the side and rear watching camera monitor system in the displaying of the side and rear images on the display unit; and
supplying power to the side and rear watching camera monitor system through the regulator and processing an image signal.

15. The method of claim 10, wherein the performing the defect inspection further includes:
determining whether a voltage applied to the controller from a vehicle falls within a normal range and performing defect inspection of a camera and defect inspection of the display unit.

16. The method of claim 15, wherein the performing the defect inspection of the camera further includes:
determining whether a voltage applied to the camera from the controller falls within a normal range and performing communication defect inspection between the controller and the camera.

17. The method of claim 15, wherein the performing the defect inspection of the display unit further includes:
determining whether a voltage applied to the display unit form the controller falls within a normal range and performing communication defect inspection between the controller and the display unit.

18. The method of claim 15, wherein the determining whether the voltage applied to the controller from the vehicle falls within the normal range and the performing the defect inspection of the camera and the defect inspection of the display unit further includes:
initializing the camera monitor system in a case of a normal state.

19. The method of claim 15, wherein the determining whether the voltage applied to the controller from the vehicle falls within the normal range and the performing the defect inspection of the camera and the defect inspection of the display unit further includes:
converting the camera monitor system into an off-state or providing an alarm to a user when the defect occurs.
